(19) United States
(12) Patent Application Publication
(10) Pub. No.: US 2016/0257234 A1
(43) Pub. Date: Sep. 8, 2016

(54) AUTOMOTIVE CUP HOLDER

(71) Applicant: DARRELL LEE GOMES, West Warwick, RI (US)

(72) Inventor: DARRELL LEE GOMES, West Warwick, RI (US)

(21) Appl. No.: 14/961,683

(22) Filed: Dec. 7, 2015

Related U.S. Application Data
(60) Provisional application No. 62/091,597, filed on Dec. 14, 2014.

(51) Int. Cl. B60N 3/10

(52) U.S. Cl. CPC B60N 3/103

(57) ABSTRACT

The design is for an automotive cup holder that can be mounted on the door and provide easier accessibility without interfering with switches and controls on the center console. It also is larger in design to accommodate larger drink containers.

### TECHNICAL FIELD

The item described is a cup holder designed specifically for to replace the small, poorly positioned cup holders that come in a Mini Cooper automobile. The factory design is small and in a position which it can interfere with vital control switches in the vehicle.

It will be made with an automotive grade ABS plastic, created in a CNC mold. The unit is designed to attach perfectly to the drivers door.

### DISCLOSURE OF INVENTION

The factory cup holders are designed to hold a 12 ounce soda can.

My new design allows the user to use a larger coffee cup or soft drink cup. The original design from the manufacturer does not allow this because of limited space. Also the factory design when in use, blocks window and door switches. It can also accidentally trigger the heated seats and traction control buttons. My design mounts on the door, away from all the controls and also provides room to hold larger cups.

### BRIEF DESCRIPTION OF DRAWINGS

FIG. 1 is a perspective view of the cup holder and how it will attach to the door.

FIG. 2 is a right side view. It shows the top hook which mounts on the door pull handle and the notch on the bottom which fits over the pocket rail and helps keep it stable and secure.

FIG. 3 is a left side view. It shows the notch on the bottom, also designed to help stabilize the unit.

FIG. 4 is a top view. It shows the actual cup cavity and also the bevel at the top.

FIG. 5 is a back view.

### DETAILED DESCRIPTION OF DRAWINGS

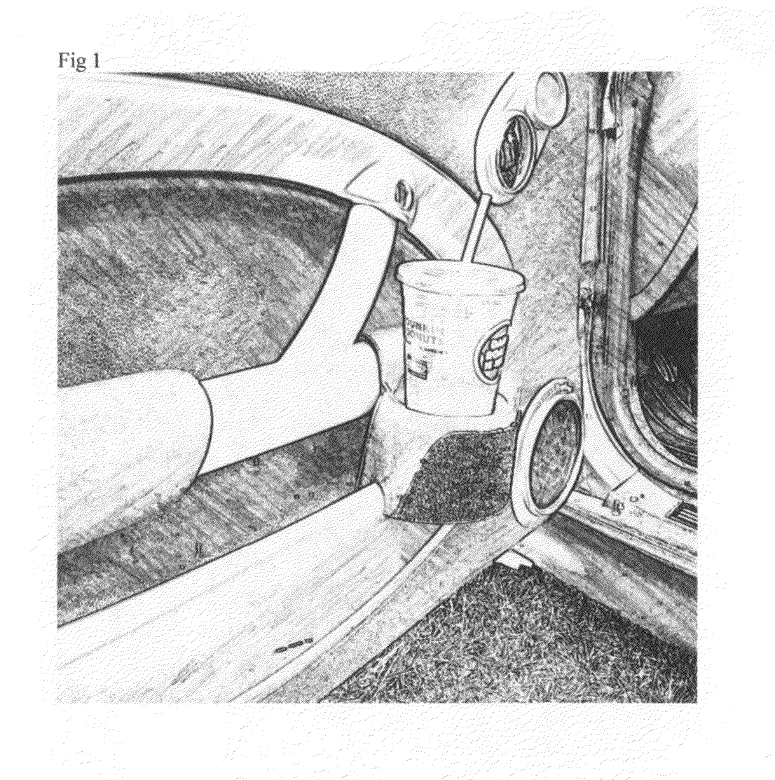

FIG. 1 shows how the upper hook portion secures to the pull handle on the door. The bottom of the cup holder shows how it secures to the door pocket rail to further increase stability.

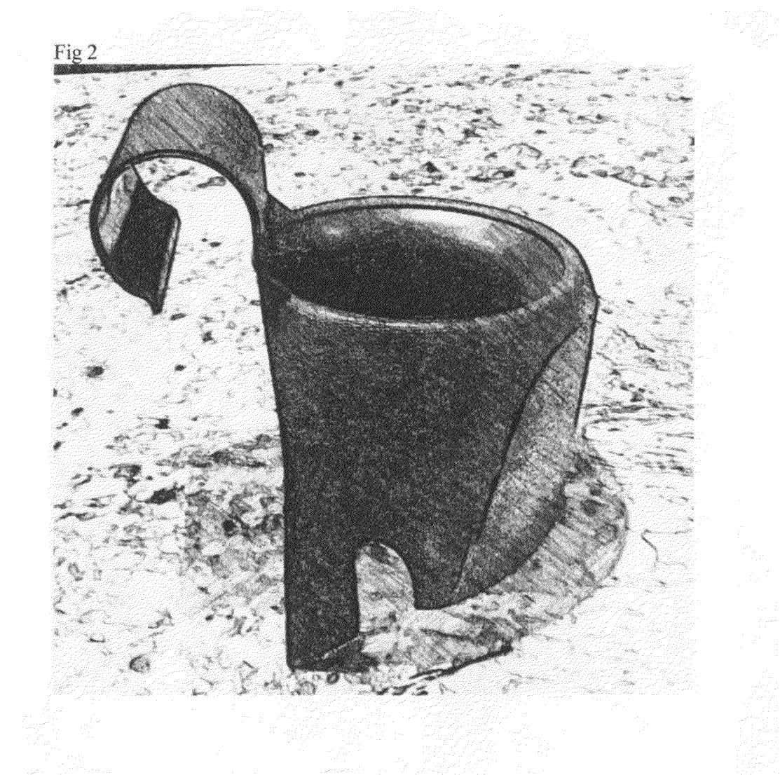

FIG. 2 shows the gripping hook and how it provides tension to the pull rail to help keep it secure.

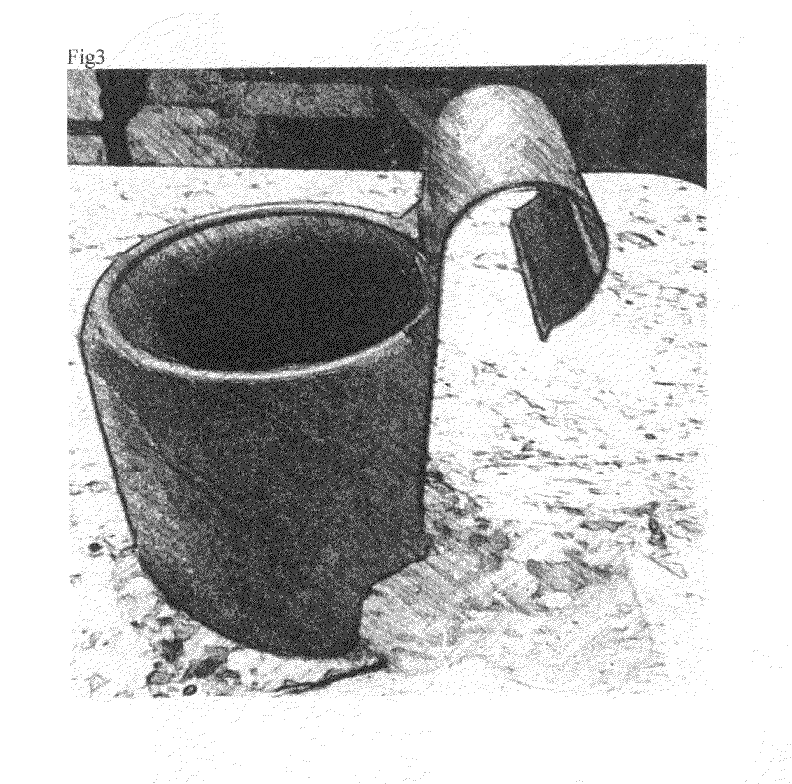

FIG. 3 shows the left side view with the cut out notch to help stabilize the cup holder.

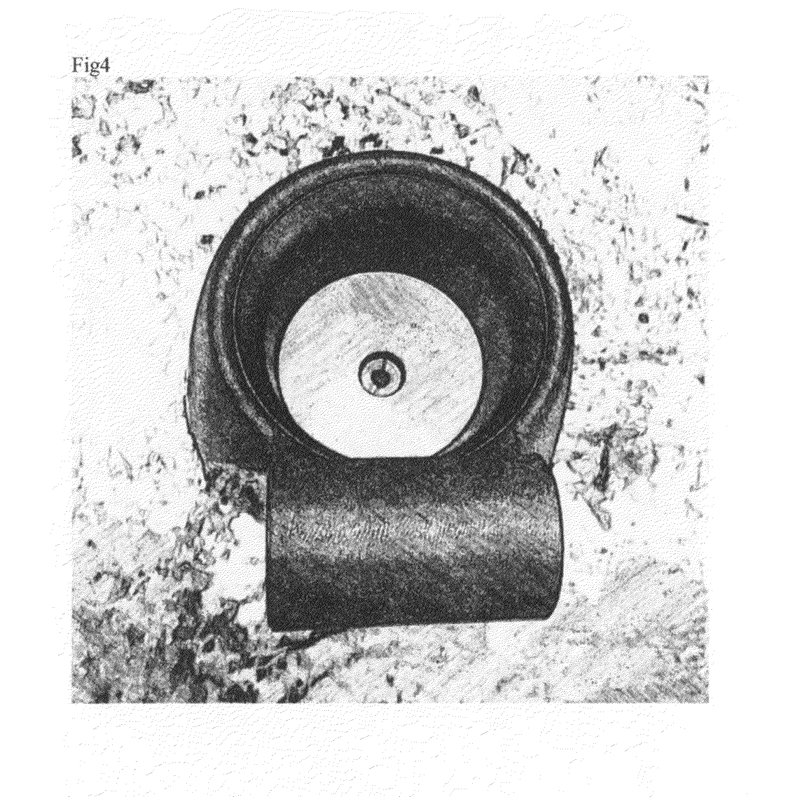

FIG. 4 shows the taper of the inside of the cup holder which will allow for larger cup sizes to be used.

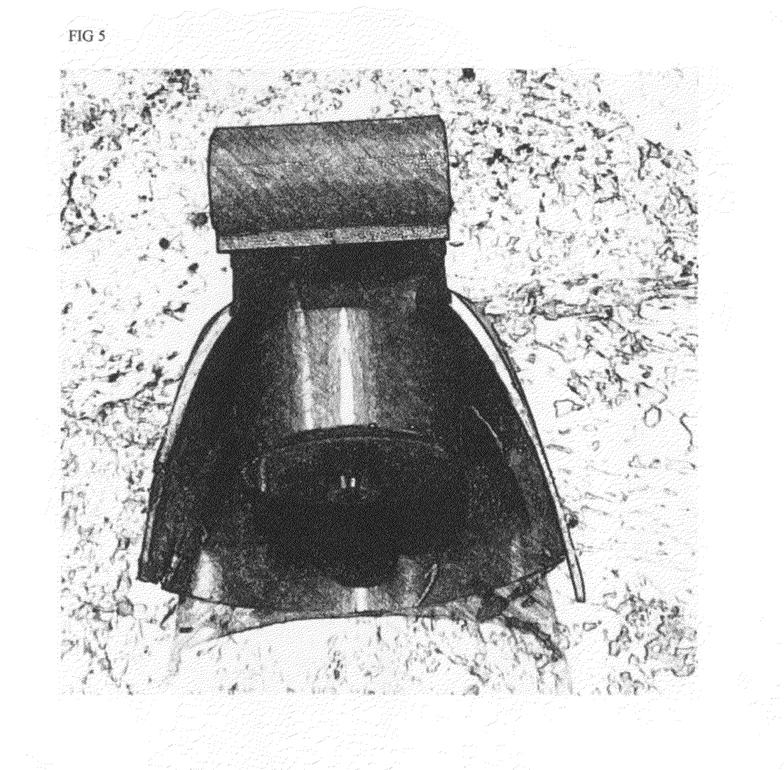

FIG. 5 shows the back view with the wide profile for added stability.

It also shows the depth of the cup holder and the width of the upper retaining clamp.

A portion of the disclosure of this patent document contains material which is subject to copyright protection. The copyright owner has no objection to the facsimile reproduction by anyone of the patent document or patent disclosure, as it appears in the Patent and Trademark Office patent file or records, but otherwise reserves all copyright rights whatsoever.

1. The item described is a cup holder that is designed specifically for Mini Cooper automobiles. Its purpose is to provide a cup holder with easier accessibility and greater safety than the factory cup holders.
The manufacturer design has created problems when using the cup holder.
They are located in a position where other controls ie. heated seat switches, door lock switch, window switches and traction control switches, can be accidentally activated when putting a cup in the holder. These actions can cause a distraction which can resulting an accident or loss of vehicle control in foul weather if traction control is accidentally shut off.
The other problem is that the factory design is for a small cup or a soda can. It will not accommodate larger cups or travel mugs. My design is located on the drivers door at a very ergonomic position. It is easily accessible and located in a safe location away from any switches. Driver does not need to look away from the road to locate drink. It will be right next to left hand and will allow the driver to focus on driving without any distraction.
